(19) United States
(12) Patent Application Publication
(10) Pub. No.: US 2008/0005155 A1
(43) Pub. Date: Jan. 3, 2008

(54) System and Method for Generating a Service Oriented Data Composition Architecture for Integrated Asset Management

(75) Inventors: Ramakrishna Soma, Los Angeles, CA (US); Amol Bakshi, Pasadena, CA (US); Abdollah Orangi, Irvine, CA (US); Viktor K. Prasanna, Pacific Palisades, CA (US); William J. Da Sie, Danville, CA (US)

Correspondence Address: BUCHANAN, INGERSOLL & ROONEY PC, POST OFFICE BOX 1404, ALEXANDRIA, VA, 22313-1404, US

(73) Assignees: University of Southern California, Los Angeles, CA (US); Chevron U.S.A. Inc., San Ramon, CA (US)

(21) Appl. No.: 11/734,221

(22) Filed: Apr. 11, 2007

Related U.S. Application Data
(60) Provisional application No. 60/791,484, filed on Apr. 11, 2006.

(51) Int. Cl. G06F 17/00

(52) U.S. Cl. 707/102; 707/E17.005

(57) ABSTRACT

Systems and methods are directed to modeling an asset in an integrated asset management framework. To model the asset an interface generates a workflow through a plurality of domain objects associated with the asset. A directory manages a mapping of services to the plurality of domain objects, and a compiler generates a schedule of service calls based on the mapping of services to the domain objects in the directory. A workflow engine executes the schedule of service calls to produce a workflow model of the asset.

### RELATED APPLICATION

This application claims a priority benefit under 35 U.S.C. §120 of Provisional Application No. 60/701,484 filed on Apr. 11, 2006, the contents of which are hereby incorporated in its entirety by reference.

### BACKGROUND

1. Field

Systems and methods for generating a service oriented architecture for data composition in a model based Integrated Asset Management framework.

2. Background Information

Integrated Asset Management (“IAM”) systems tie together or model the operations of many physical and non-physical assets or components of an oilfield. Examples of physical assets or components might include subterranean reservoirs, well bores connecting the reservoirs to pipe network systems, separators and processing systems for processing fluids produced from the subterranean reservoirs and heat and water injection systems. Non-physical assets or components can include reliability estimators, financial calculators, optimizers, uncertainty estimators, control systems, historical production data, simulation results, etc. Two examples of commercially available software programs for modeling IAM systems include AVOCET™ IAM software program, available from Schlumberger Corporation of Houston, Tex. and INTEGRATED PRODUCTION MODELING (IPM™) toolkit from Petroleum Experts Inc. of Houston, Tex.

IAM presents an intensive operational environment involving a continuous series of decisions based on multiple criteria including safety, environmental policy, component reliability, efficient capital, operating expenditures, and revenue. Asset management decisions involve interactions among multiple domain experts, each capable of running detailed technical analysis on highly specialized and often compute-intensive applications. Technical analysis executed in parallel domains over extended periods can result in divergence of assumptions regarding boundary conditions between domains. A good example of this is pre-development facilities design while reservoir modeling and performance forecasting evaluations progress. Alternatively, many established proxy models are incorporated to meet demands of rapid decision making in an operational environment or when data is limited or unavailable.

Exemplary goals of an Integrated Asset Management (IAM) framework for use in an oil and gas industry application are twofold. First, from an end users' perspective, the framework should offer a single, easy-to-use user interface for specifying and executing a variety of workflows from reservoir simulations to economic evaluation. Second, from a software perspective, the IAM framework should facilitate seamless interaction of diverse and independently developed applications that accomplish various sub-tasks in an overall workflow. For example, the IAM framework should pipe the output of a reservoir simulator running on one machine to a forecasting and optimization toolkit running on another and in turn piping its output to a third piece of software that can convert the information into a set of reports in a specified format.

An exemplary IAM framework will incorporate a number of information consumers such as simulation tools, optimizers, databases, real-time control systems for in situ sensing and actuation, and also human engineers and analysts. The data sources in the system are equally diverse, ranging from real-time measurements from temperature, flow, pressure, and vibration sensors, on physical assests such as oil pipelines to more abstract data such as simulation results, maintenance schedules of oilfield equipment, and market prices, for example.

In many workflows, intermediate processing is used for the data produced by one tool (service). This intermediate processing includes a data conversion involving a reformatting of data or more complex transformations such as unit conversions (e.g., barrels to cubic meters), and aggregation (e.g., well production to block production), for example. Specific interpolation policies could be required to fill in a data set with missing values.

### SUMMARY

An exemplary embodiment includes a system for modeling an asset in an integrated asset management framework. The system comprises an interface for generating a workflow through a plurality of domain objects associated with the asset, and a directory for managing a mapping of services to the plurality of domain objects. The system also comprises a compiler for generating a schedule of service calls based on the mapping of services to the domain objects in the directory, and a workflow engine that executes the schedule of service calls to produce a workflow model of the asset.

An exemplary method for modeling a workflow in an integrated asset management framework comprises defining a plurality of elements and relationships between each element to identify data types and transformations to be performed on each data type. The method also comprises specifying each element to be used in generating the workflow by defining conditions for executing each element, executing the generated workflow, and updating each element based on results produced from the executed workflow.

Additionally, an exemplary method of modeling data composition in an integrated asset management framework for simulating an entity workflow is disclosed. The method comprises generating a catalog of reference curves from the entity workflow simulations, and acquiring real world production data of the entity to generate a type curve of the production data. The method also includes comparing time-based data derived from the reference curves and the type curve along predetermined dimensions, and estimating a best fit pattern from a set of reference curves in the catalog and a type curve of the production data.

An exemplary computer readable medium containing a program for executing a method for modeling a workflow in an integrated asset management framework is disclosed. The program performs the steps of generating an interface for defining a plurality of elements and relationships between each element to identify data types and transformations to be performed on each data type, and generating a directory to manage a mapping of services to each element based on the element definitions. The program also compiles the workflow to generate a schedule of service calls based on the mapping of services to the elements in the directory, and executes the schedule of service calls to produce a workflow model of the elements.

### DESCRIPTION OF THE DRAWINGS

In the following, exemplary embodiments will be described in greater detail in reference to the drawings, wherein:

FIG. 1 illustrates a schematic diagram of a system architecture in accordance with an exemplary embodiment;

FIG. 2 illustrates a schematic diagram of data schema in accordance with an exemplary embodiment;

FIG. 3 illustrates a schematic diagram of data composition schema in accordance with an exemplary embodiment;

FIG. 4 illustrates a schematic diagram of domain model schema in accordance with an exemplary embodiment;

FIG. 5 illustrates a data type library in accordance with an exemplary embodiment;

FIG. 6A illustrates a properties aspect of a data composition schema in accordance with an exemplary embodiment; and

FIG. 6B illustrates a main aspect of a data composition schema in accordance with an exemplary embodiment.

### DETAILED DESCRIPTION

Systems and methods of the IAM framework disclosed herein are directed to a service-oriented software architecture for data composition. The IAM framework includes a graphical modeling front-end, the data composition language, an IAM compiler that orchestrates workflow execution based on a users' specification.

To accomplish these objectives, the IAM framework can be based on a model-integrated system design. In the model-integrated system design, the IAM can be configured to define a domain-specific modeling language for structured specification of all relevant information about an asset being modeled. The resulting model of the asset captures information about many physical and non-physical aspects of the asset and stores it in a model database. The model database can be in a canonical format that can be accessed by any of a number of tools in the IAM framework. The tools can be accessed through well-defined application program interfaces (APIs).

In a model-based IAM framework, the asset model acts as a central coordinator of information access and data transformation. The asset model interfaces each tool with the model database such that the database enables indirect coupling of disparate applications by allowing them to collaboratively work together in a common context of the asset model. In this manner, the asset model provides a front-end modeling environment to the end user. The front-end modeling environment allows definition and modification of the asset model, and also contains a mechanism to allow the invocation of one or more integrated tools that act on different parts of the asset model.

The IAM framework can also be configured as a service oriented architecture (SOA). The SOA is a style of architecting software systems by packaging functionalities as services that can be invoked by any service requester. An SOA typically implies a loose coupling between modules by wrapping a well-defined service invocation interface around a functional module. In this manner, the SOA hides the details of the module implementation from other service requesters. This feature enables the IAM framework to provide software reuse and localizes changes to a module implementation so that the changes do not affect other modules as long as the service interface is unchanged.

Web-services form an attractive basis for implementing service-oriented architectures for distributed systems. Web services rely on open, platform-independent protocols and standards, and allow software modules to make themselves accessible over the Internet.

When the service-oriented is adopted for designing an IAM framework, every component, regardless of its functionality, resource requirements, language of implementation, among others, provides a well-defined service interface that can be used by any other component in the framework. The service abstraction provides a uniform way to mask a variety of underlying data sources (e.g., real-time production data, historical data, model parameters, and reports) and functionalities (e.g., simulators, optimizers, sensors, and actuators). Workflows can be composed by coupling service interfaces in the desired order. The workflow specification can be through a graphical or textual front end and the actual service calls can be generated automatically.

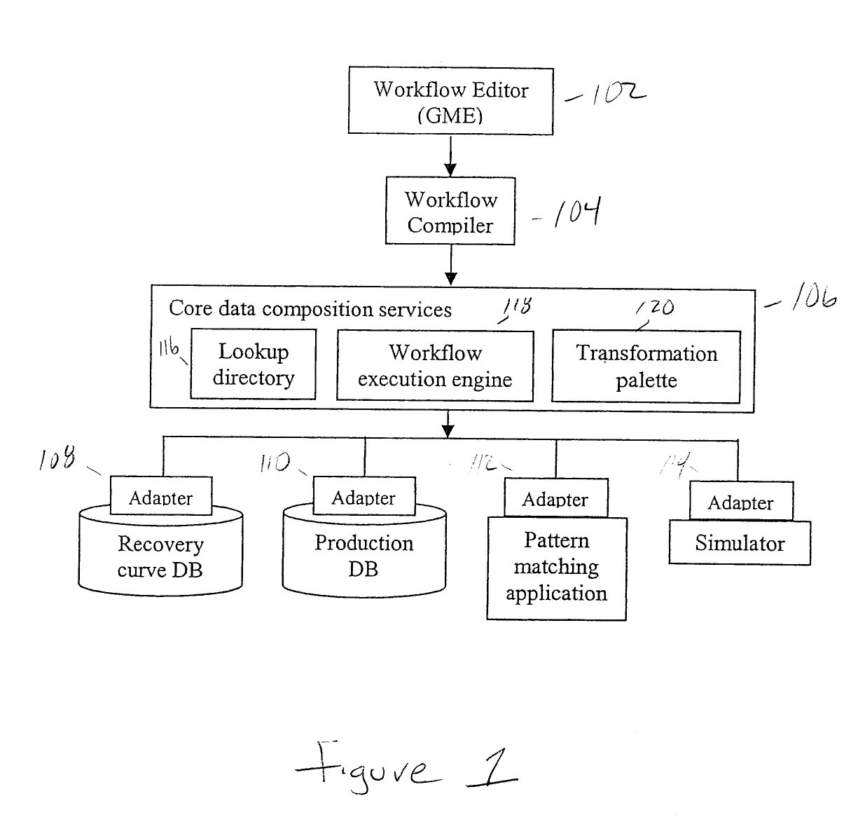

FIG. 1 is a schematic diagram of a system architecture of a data composition framework in accordance with an exemplary embodiment. The architecture can be configured based on generality and reuse. As described herein, generality describes a feature of the architecture that enables many different data composition scenarios. Generality is related to the expressiveness of the data composition language and determines the range of applications supported by the IAM framework. Reuse indicates that the architecture can be configured with various combinations of off-the-shelf components, as desired.

The system architecture 100 includes a workflow editor 102, a workflow compiler 104, data composition services 106, and a plurality of adaptors 108, 110, 112, and 114. The workflow editor 102 provides the domain-specific visual modeling language for data composition in the IAM workflow. The workflow editor 102 can be implemented through a graphical modeling toolsuite, or any other suitable software application as desired, that can be configured to automatically generate a graphical modeling environment (GME) based on a modeling language specification. Through the workflow editor 102, workflows can be defined in terms of domain objects, a set of pre-determined “methods” of the domain objects, and a set of workflow primitives.

The workflow compiler 104 can be configured to compile the domain objects, which define each workflow, to produce a workflow that consists of a series of service invocations. The workflow compiler 104 converts the high-level description language of the workflow editor 102 into an executable workflow. For example, the workflow compiler 104 can produce an output such as a schedule that is executable by a workflow engine such as a Microsoft SQL for Integration Services (MS SSIS), a Business Process Execution language (BPEL), or other suitable modeling language as desired. To produce an output, the workflow compiler 104 translates the high-level object references to calls to actual data-sources that are associated with or serving that data. The translation involves requesting the data composition services 106 to provide the best data source for the required data type and quality metrics. The workflow compiler 104 produces a schedule that contains a sequence of web-service calls that should be performed, and converts custom transformations which are specified in the description language into appropriate calls to the transformation palette component of the data composition services 106.

The workflow compiler 104 produces an output based on data provided by data composition services 106. Data composition services 106 can include a lookup directory 116, a workflow engine 118, and a transformation palette 120. The lookup directory 116 keeps a mapping of a service that accommodates a specific data type by storing meta-data for each service. In addition, the lookup directory 116 can keep track of other metrics like data quality so that the workflow compiler 104 can select the best data source when multiple data sources serve the same data. For example, the lookup directory 116 can store metadata that describes a source, a type of object, a range of objects, transformations on data objects, and data quality.

The source metadata is used when the requestor knows the source from which the data needs to be fetched, and can also provide hints about the quality of the data supplied by the data source. The source metadata can be implemented as Dublin core metadata schema or any other suitable metadata schema as desired.

The metadata defining an object type is information that enables the lookup directory 116 to resolve the data specifications to the data sources. The range of objects metadata provides information when a data source supplies only a specified range of data objects. The transformation on the data objects metadata provides a mapping of the data object method to a corresponding port of the service accommodating or associated with the object method. Data quality metadata provides information related to a data object such as freshness/recency of the data, completeness of the data, and accuracy of the data, and/or any other suitable information that describes data quality as desired. This information can be used when more than one data source supplies the same piece of information and the system needs to choose the right piece of data that is suitable for the decision to be made.

The lookup table 116 can be implemented in a distributed manner or any other suitable scheme as desired, so that a scalability of the system can be increased. As a result, the lookup table is not a single monolithic component but rather is composed of multiple components organized hierarchically, with each lookup component in the hierarchy indexing a subset of the data sources. When the “root” lookup component receives a request for some data transformation, the lookup table 116 can delegate the request to the right component in the hierarchy.

The data and computational resources can be of the abstracted as web services. This abstraction provides a uniform interface and protocols to address each resource, considerably decreasing the complexity of integration. Apart from providing the data and computational resources, the web services in the system provide the meta-data information to the framework. In general each service can have the following interface:

IAMCOOLService{
Init( );
Stop( );
XMLDoc getData (String objType, Query spec);
//Set of data transformations it provides.
XMLDoc transformation1( );

Init is the initialization process where the data sources advertise themselves to the lookup table 116 and provide it the lookup table 116 with the meta-data described above. The stop method is called when the service needs to be shutdown. This method is the inverse of the init method where the lookup table 116 removes the current service as providing the data and the transformations advertised in the init process. In the getData method of the interface, the data source finds the data that is of the same type as the first parameter and matches the data specification. It returns an XML document containing the required data. One skilled in the art will appreciate that the queries can be specified in Xquery or other suitable querying language as desired.

In building such systems, most of the data sources already exist (legacy data sources) with their own proprietary interfaces. A well-accepted technique (design pattern) to integrate such legacy data/computational sources is to provide them with wrappers. The wrappers provide a web-service abstraction to the data source and present the above-mentioned interface to the system.

The workflow engine 118 collaborates with the workflow compiler 104 to execute schedules generated by the workflow compiler 104.

The transformation palette 120 can be configured to provide a set of transformations that can be readily applied to the data from the data composition services job. The transformation palette 120 can include a simple set of primitives including the relational operators such as project, select, join or other suitable operations as desired, and mathematical and aggregation/statistical operators such as add, multiply, or other operations as desired to make the framework more powerful.

A time reservoir management workflow can be used to illustrate an implementation of the system architecture 100 of FIG. 1. In this workflow for example, a catalog of type curves is available from a series of a priori reservoir simulation runs. The curves in the catalog correspond to a set of differing models of the reservoir. As real world production data from the reservoir becomes available, it can be periodically compared to the type curves in the catalog to estimate the best fit. The type curve(s) that best matches the production data at a given time could then be used as input to other disjoining workflows such as oil production forecasting.

The workflow can be analyzed from a data composition perspective. This analyzing involves identifying data sources, an aggregation service, and a pattern matching service, or other suitable characteristics of the modeling language that are associated with the data as desired. The production data and the recovery curve catalog are the sources of ‘raw’ data that could be stored in a standard data base. Access to the database could be through a web service that provides a query interface for data retrieval and update. A software module aggregates time-based raw data (from production as well as simulation), and generates type curves along with the desired dimensions—e.g., cumulative oil production vs. reservoir pressure or any other comparison as desired. This software module accepts a set of reference curves from the catalog and a type curve derived from the production data, and performs pattern matching to estimate the best fit.

The prototype domain-specific visual modeling language for data composition in the IAM workflow can be configured to automatically generate a graphical modeling environment based on a modeling language specification.

The modeling language includes means, such as a DataElement for defining basic data types that are exchanged between services, means such as a Composition for specifying transformations to be applied to the data, and means such as a Domain Model for linking the data composition model to the asset model.

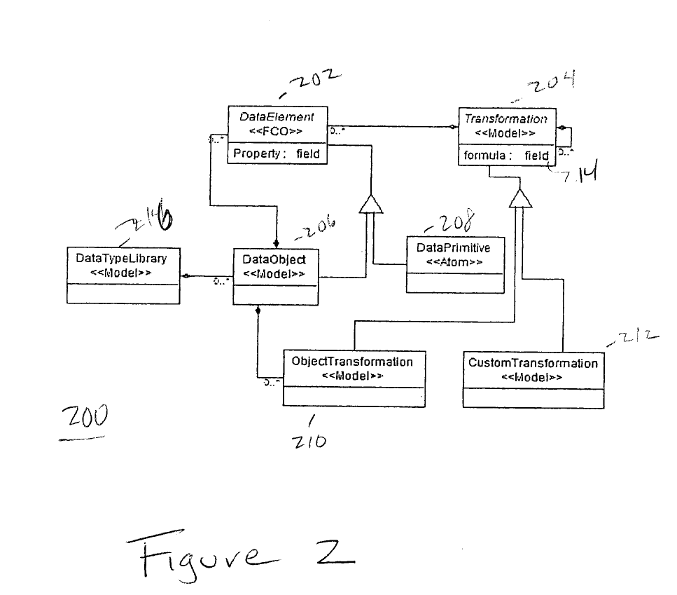

FIG. 2 illustrates a schematic diagram of data schema in accordance with an exemplary embodiment. The data schema 200 defines the entities and relationships to capture the data types and the methods/transformations on them. Thus the main elements of the data schema are a DataElement 202 and a Transformation 204. The DataElement 202 is either a DataObject 206, which is an abstraction of a domain specific object or a DataPrimitive 208. DataPrimitives 208 are primitive data types like integer, Boolean, or other suitable data type as desired.

The Transformation 204 is used to define transformations on the DataElements 202. The Transformation 204 can either be an ObjectTransformation 210 which is a predefined transformation on the DataObject 206 entities or a CustomTransformation 212 which refers to user-defined transformations. Each Transformation 204 has an associated attribute called Formula 214 which specifies the data processing that needs to be done in the transformation. Currently, the formula 214 is a block of text that specifies a sub-routine in a standard programming language such as C or any other suitable programming language as desired.

To use the framework as implemented through the system architecture 100 in a DataType Library 216 library of the identified DataObject types and Transformations 204 (or methods in object-oriented terminology) is constructed. These objects are then instantiated by the user while composing a specific workflow.

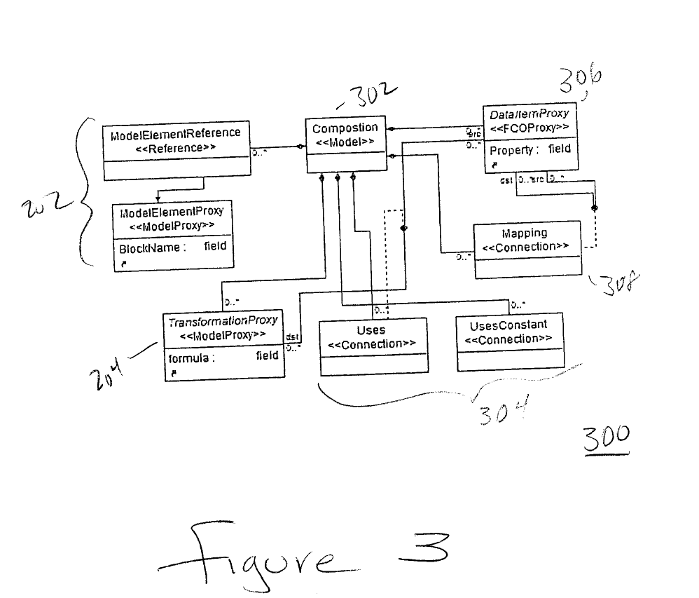

FIG. 3 illustrates a schematic diagram of data composition schema in accordance with an exemplary embodiment. The data composition schema 300 defines any entities that can be required to compose workflows using the elements from the data schema 210. The data composition schema 300 includes a Composition element 302. The Composition 302 contains the DataElements 202 and the Transformations element 204. The type of the DataElements 206 used in the data compositions is obtained from the library of DataObjects 216.

While specifying data composition, it may not be sufficient to indicate the types of data to be transformed. In addition, it may be desired necessary to specify which instances of that type of data are to be ‘composed’. For example, a composition might only use data related to a particular reservoir volume element (block). The user can define a range of the data to be used, in terms of elements from the particular asset model. This specification is done in a separate aspect of the model, called the Properties aspect 304, where the user provides a declarative expression to define the conditions that the required data needs to satisfy.

Although there is an overlap between the elements in the data schema and the composition schema, the reason for separating them is to clearly distinguish the data definition aspect from the data composition aspect. The data definition stage, where the domain objects are identified and defined (ideally) occurs just once. These objects are then used many times just as a library is used in a programming language in the composition stage.

The data composition schema 300 also can be configured to include an isConstant element 304 and a DataItem element 306. Both the isConstant element 306 and the DataItem element 308 are constants to be used in data composition can be declared by setting the is Constant property of the DataItem 308 to true.

The data composition schema 300 also includes means, such as input and output ports for enabling the composition to be resuable. A Mapping connection 308 exposes the data produced by a composition as ports so that the composition can be reused. As a result, a user-defined composition model can be reused in other workflows in the same manner as the built-in Transformation object.

The modeling language described herein can be totally independent of web services. One of ordinary skill will appreciate that the concepts of web services and SOA can be key enablers of IAM framework. Instead, the focus of the modeling language is on specifying the data objects and transformations, without placing a lesser emphasis on worrying about how the data is sourced and where the transformations are carried out.

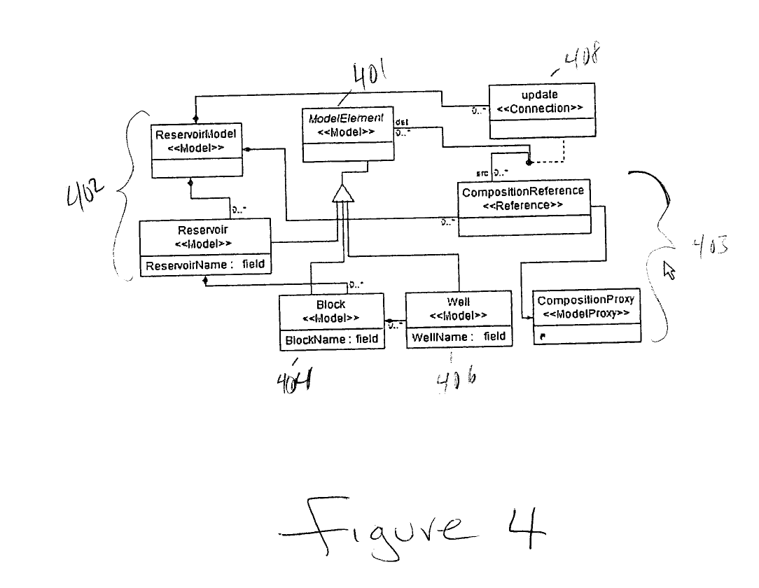

FIG. 4 illustrates a schematic diagram of a domain model schema in accordance with an exemplary embodiment. The domain modeling schema 400 is used to specify the asset. Each element in the model 401 (representing a physical or nonphysical aspect of the asset) has data associated with it, which represents some relevant information like the current state/configuration of the asset. The main objective of the domain model schema is provide mechanisms to keep this information updated, by using results to a data composition workflow 403 to update the suitable section of the asset model. The domain model schema enables the user specify the elements of the model database to be updated by the results of the composition.

As shown in FIG. 4, the domain model schema 4 is a small and highly simplified schema for modeling a reservoir 401. In this model, Reservoirs 402, Blocks 404 and Wells 406 can be represented. The update element 408 allows the user to specify that the results of the composition can be used to update the model database.

The discussion that follows relates to an illustrative example of how the modeling language is used.

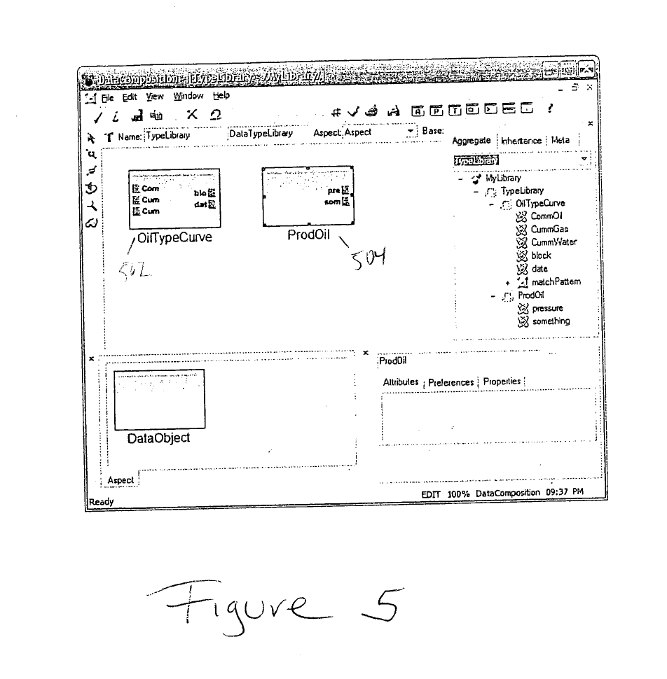

First, the data objects are defined in a type library. As shown in FIG. 5, the data type library includes a plurality of data-types including OilTypeCurve 502 and ProdOil 504. The oilType Curve object is an abstraction used to represent a schema that includes cumulative oil production, cumulative water production, or other production parameter as desired. The oilType Curve 502 also encapsulates a transformation called matchPattern which compares two oil type curves and returns a similarity index.

In order to describe the composition, a project based on the Composition schema is created. The type library defied previously is imported into the project, and provides the building blocks for the composition model. A new Composition object is instantiated, and two OilTypeCurve objects 502A and 502B are added to it.

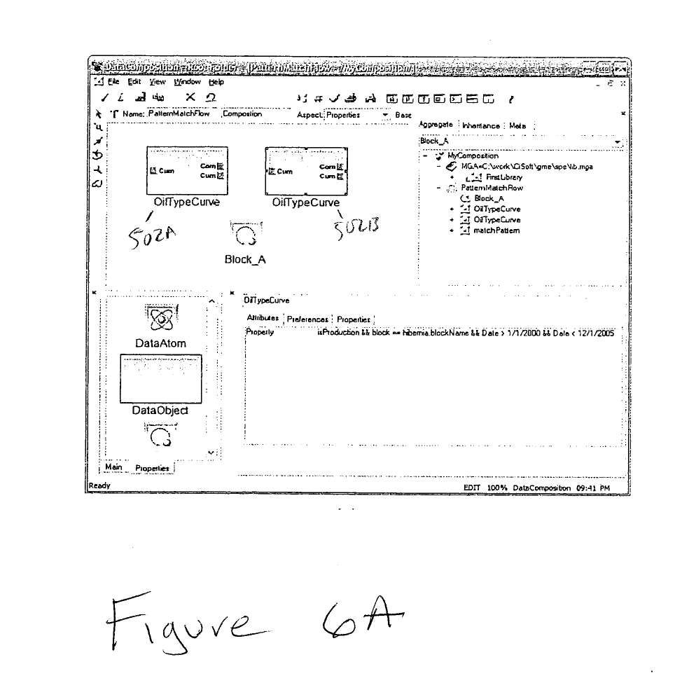

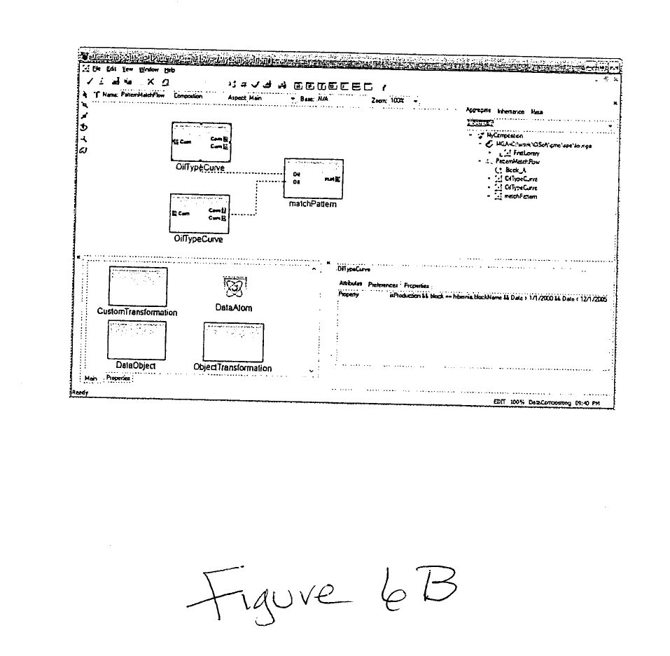

Next, the properties of the objects are described. FIG. 6A illustrates a properties aspect of the data composition schema. As shown in FIG. 6A, for example, the type curve is required for the block named Block_A. The other properties are also defined declaratively on the data objects. The property field of the two OilTypeCurves 502A and 502B is as follows:

Property a:

Src=“simulation” && block=Block_A.blockName && Date >1/1/2000 && Date <12/1/2005

Property b:

Src=“production” && block=Block_A.blockName && Date >1/1/2000 && Date <12/1/2005

Note that the “Block_A” in the property specification is a reference (pointer) to the Block_A object in the composition model. Thus, the context of the specification forms the namespace for resolving the references in the properties declaration. FIG. 6B illustrates a main aspect of the data composition schema in accordance with an exemplary embodiment. As shown in FIG. 6B, the Block_A object in the composition model is linked to the corresponding block entity in the asset model.

After this description is presented to the system, it is complied and the data satisfying the composition is fetched.

Related application No. ______ filed on Apr. 11, 2007 and entitled “A System and Method for Oil Production Forecasting and Optimization in a Model-Based Framework”, application Ser. No. 11/505,163 filed on Aug. 15, 2006 and entitled “Method and System for Integrated Asset Management Utilizing Multi-Level Modeling of Oil Field Assets”, and application Ser. No. 11/505,061 filed on Aug. 15, 2006 and entitled “Modeling Methodology for Application Development in the Petroleum Industry” are all commonly assigned, the contents of which are hereby incorporated in their entirety by reference.

While the invention has been described with reference to specific embodiments, this description is merely representative of the invention and not to be construed as limiting the invention. Various modifications and applications may occur to those skilled in the art without departing from the true spirit and scope of the invention as defined by the appended claims.

1. A system for modeling an asset in an integrated asset management framework, the system comprising:
an interface for generating a workflow through a plurality of domain objects associated with the asset;
a directory for managing a mapping of services to the plurality of domain objects;
a compiler for generating a schedule of service calls based on the mapping of services to the domain objects in the directory; and
a workflow engine that executes the schedule of service calls to produce a workflow model of the asset.

2. The system of claim 1, wherein the directory identifies a data source for providing data associated with each domain object.

3. The system of claim 2, wherein the compiler translates each service call into data sources that service each domain object.

4. The system of claim 3, wherein during translation the compiler sends a request to the directory to identify the best data source for serving each domain object.

5. The system of claim 4, further comprising a transformation palette that identifies transformations that each data source can apply to a domain object.

6. The system of claim 1, wherein the directory identifies a range of objects served by each service.

7. The system of claim 1, wherein the directory identifies types of objects that are served by each service.

8. A method for modeling a workflow in an integrated asset management framework, the method comprising:
defining a plurality of elements and relationships between each element to identify data types and transformations to be performed on each data type;
specifying each element to be used in generating the workflow by defining conditions for executing each element;
executing the generated workflow; and
updating each element based on results produced from the executed workflow.

9. The method of claim 8, further comprising:
exposing data produced by each element as ports so that the elements can be used in other workflows.

10. A method of modeling data composition in an integrated asset management framework for simulating an entity workflow, the method comprising:
generating a catalog of reference curves from the entity workflow simulations;
acquiring real world production data of the entity to generate a type curve of the production data;
comparing time-based data derived from the reference curves and the type curve along predetermined dimensions; and
estimating a best fit pattern from a set of reference curves in the catalog and a type curve of the production data.

11. A computer readable medium containing a program for executing a method for modeling a workflow in an integrated asset management framework, the program performing the steps of:
generating an interface for defining a plurality of elements and relationships between each element to identify data types and transformations to be performed on each data type;
generating a directory to manage a mapping of services to each element based on the element definitions;
compiling the workflow to generate a schedule of service calls based on the mapping of services to the elements in the directory; and
executing the schedule of service calls to produce a workflow model of the element.

12. The computer readable medium of claim 11, wherein generating the directory comprises identifying a data source for providing data associated with each element.

13. The computer readable medium of claim 12, wherein compiling the workflow comprises translating each service call into data sources that service each element.

14. The computer readable medium of claim 13, wherein translating each service call comprises sending a request to the directory to identify the best data source for serving each element.

15. The computer readable medium of claim 14, wherein the program is configured to identify transformations that each data source can apply to an element.
